(19) United States
(12) Patent Application Publication
(10) Pub. No.: US 2015/0032818 A1
(43) Pub. Date: Jan. 29, 2015

(54) INTEGRATED EVENT SYSTEM

(71) Applicant: SquadUP, New York, NY (US)

(72) Inventor: William Litvack, New York, NY (US)

(21) Appl. No.: 14/444,610

(22) Filed: Jul. 28, 2014

Related U.S. Application Data
(60) Provisional application No. 61/859,583, filed on Jul. 29, 2013.

(51) Int. Cl. H04L 29/08; H04L 29/06; H04W 4/02; G06F 17/22

(52) U.S. Cl. CPC H04L 67/10; G06F 17/2247; H04L 65/403; H04W 4/02
USPC 709/204

(57) ABSTRACT

One embodiment is directed to a system for assisting an operator to view events, comprising: a first centralized computing system; and a mobile computing device operatively coupled to the first centralized computing system and configured such that a mobile location may be determined based at least in part upon wireless communications between the mobile computing device and one or more remote transceivers positioned in known locations; wherein the first centralized computing system is configured to operate an event management webservice, and is operatively coupled to a second centralized computing system containing social networking data; and wherein the mobile computing device may be operated to view a selection of event data received from the first centralized computing system that has been selected based at least in part upon the mobile location and the social networking data.

### RELATED APPLICATION DATA

The present application claims the benefit under 35 U.S.C. §119 to U.S. provisional patent applications Ser. No. 61/859,583 filed Jul. 29, 2013. The foregoing application is hereby incorporated by reference into the present application in its entirety.

### FIELD OF THE INVENTION

The present invention is related to connected applications for facilitating event organization, and specifically to a system for utilizing connected computing systems to view or select one or more events wherein the operator's mobile device location and aspects of connected social networking information are inputs.

### BACKGROUND

A modern information technology consumer operating a device such as a personal computer or mobile smartphone is presented with various products for assisting with scheduling, electronic payment, electronic communication, message posting, photo and other media posting, and social networking/relationship management options. For example, in the scheduling space, there are products such as those offered under the tradenames eVite®, Outlook®, or Google Apps®; in the payment space there are options such as those offered under the tradenames PayPal®, Google Wallet®, and Payza®; in the social networking space there are products such as Facebook® and GooglePlus®. To address efficiency, privacy, and security concerns, there is a need for integrated solutions which bring together and improve upon the feature sets that are current available from such conventional service providers. For example, in the event viewing, selection, and planning space, it would be valuable to have a unified technology offering that is configured to allow an operator to securely and efficiently select, view, plan, RSVP, finance, and/or create an event with integrated information from his or her already-existing social network information and to select various options for aggregating payments for such event, for travelling to such event, attending various optional features of the event, and so on, based at least in part upon inputs from the operator's social network information and/or other factors, such as the operator's location, future travel plans, known likes/dislikes, and other parameters. The subject invention is designed to address such challenges.

### BRIEF DESCRIPTION OF THE DRAWINGS

FIG. 1 illustrates a configuration wherein a mobile computer system is operatively coupled to a plurality of mobile transceivers as well as a plurality of computing systems which may be utilized as portions of an event management configuration in accordance with the present invention.

FIG. 2 illustrates various aspects of a process wherein an operator utilizes a computing device in an event management configuration in accordance with the present invention.

FIG. 3 illustrates various aspects of a process wherein an operator utilizes a computing device in an event management configuration in accordance with the present invention.

FIGS. 4A-4U illustrate various aspects of user interface images for various portions of an event management configuration in accordance with the present invention.

FIG. 5 illustrates various aspects of user interface image for a portion of an event management configuration in accordance with the present invention which also involves travel planning.

### SUMMARY OF THE INVENTION

One embodiment is directed to a system for assisting an operator to view events, comprising: a first centralized computing system; and a mobile computing device operatively coupled to the first centralized computing system and configured such that a mobile location may be determined based at least in part upon wireless communications between the mobile computing device and one or more remote transceivers positioned in known locations; wherein the first centralized computing system is configured to operate an event management webservice, and is operatively coupled to a second centralized computing system containing social networking data; and wherein the mobile computing device may be operated to view a selection of event data received from the first centralized computing system that has been selected based at least in part upon the mobile location and the social networking data. The first centralized computing system may be a webserver. The mobile computing device may be selected from the group consisting of: a mobile phone, a tablet computer, and a laptop computer. The mobile computing device may be operatively coupled to the first centralized computing system via a wireless network. The wireless network may comprise a mobile wireless network. The wireless network may comprise a WiFi network. The second centralized computing system may be a webserver. The webserver may be configured to host one or more portions of a social network platform. The one or more portions of a social network platform may comprise a database featuring user relationship information. The user relationship information may comprise contact information. The user relationship information may comprise relationship status information. The relationship status information may comprise friend status. The webserver may be configured to host one or more portions of an electronic mail platform. The one or more portions of an electronic mail platform may comprise a database featuring contact information. At least one of the one or more mobile transceivers may be a mobile wireless transceiver. A plurality of mobile wireless transceivers may be configured to be utilized to determine the mobile location with triangulation techniques. At least one of the one or more mobile transceivers may be a satellite positioning transceiver. A plurality of satellite positioning transceivers may be configured to be utilized to determine the mobile location with triangulation techniques. At least one of the one or more mobile transceivers may be a near-field-communications transceiver. A plurality of near-field-communications transceivers may be configured to be utilized to determine the mobile location with triangulation techniques. The event management webservice may be further configured such that the operator may utilize contact information comprising the social networking data to complete one or more portions of an invitation interface before dispatching to a designated group of invitees, the invitation interface comprising payment amount and payment closing date configuration options such that the operator may select a payment amount for each invitee to pay to attend the event, as well as a closing date for processing such payment amount which may be before, during, or after occurrence of the event.

### DETAILED DESCRIPTION

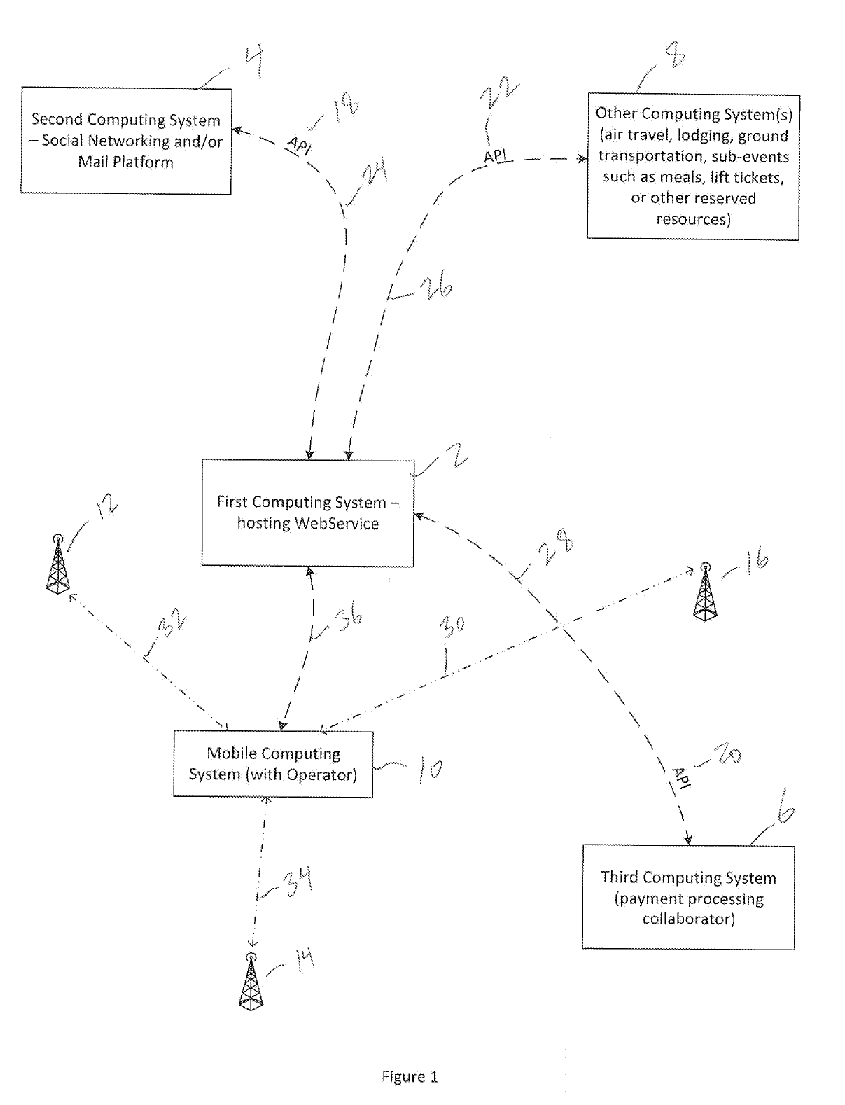

Referring to FIG. 1, a webservice for the subject event planning and management software application/service may be hosted upon a first computing system (2) which may have a centralized or distributed computing architecture. The first computing system (2) hosting the webservice preferably is available to users/operators from various computing resources local to such users/operators, such as mobile computing systems (10) including but not limited to mobile smartphones, tablet computers, and laptop computers. In other words, the first computing system (2) preferably is operatively coupled (36) to the mobile computing system (10) using a computer network, such as a wireless (i.e., such as an IEEE 802.11 type WiFi network or a mobile cellular wireless network) and/or wired computer network. Similarly, the first computing system (2) may be operatively coupled (24, 26, 28) to other computing systems (4, 8, 6, respectively). In the depicted embodiment, the first computing system (2) is operatively coupled (24), using an application programming interface, or “API”, to a second computing system that hosts a social networking software service or platform (such as Facebook® or GooglePlus®), and/or an electronic mail software service or platform (such as Gmail® or Yahoo Mail®), and is configured to provide the first computing system with social networking data such as relationship listings (such as listings of “friends”), status or relationships (i.e., best friends inner circle, acquaintances, etc), or email contact information (i.e., email addresses). The first computing system (2) is also shown as operatively coupled (28), using an API (20) to a third computing system (6) (such as those available under the tradenames BrainTree® or PayPal®) which may be configured to provide payment processing services and the requisite exchanges of data related thereto. As shown in FIG. 1, the first computing system (2) may be operatively coupled (26) using an API (22) to other computing resources (8), such as systems configured to manage air travel, lodging, ground transportation, and various other resources or sub-events within a larger event, such as meals, lift tickets, concert tickets, spa services, or other reserved resources). Thus through his or her operative coupling (36) to the first computing system (2) via his mobile device (10), the operator may have access to resources from each of these various computing systems (2, 4, 6, 8), and the software webservice hosted upon the first computing system (2) preferably is configured to allow such operation in a coordinated fashion, as described below.

Referring again to FIG. 1, another aspect of having an involved mobile computing system (10) is that such computing system may be localized (i.e., its location may be determined) using various techniques, and the localization data may be utilized as an input to the event management/viewing processing. In one embodiment, a plurality of wireless transceivers, such as three transceivers as shown (12, 14, 16), may be utilized with triangulation techniques to localize the mobile computing system (10) based upon the wireless connectivity (32, 34, 30) between the transceivers (12, 14, 16, respectively) and the connected mobile computing system; such wireless transceivers may operate using various wireless configurations/standards, such as IEEE 802.11 WiFi, WiMax, satellite GPS, Bluetooth 4.0, wireless/cellular mobile networks, near-field-communication (“NFC”). In other embodiments, localization may be conducted using wired networks. Thus FIG. 1 illustrates a configuration wherein a localized mobile device is operatively coupled with a plurality of other computing resources, and through API-based exchanges, may be able to utilize these resources and it remotely operates aspects of a first computing system hosting the subject event management webservice.

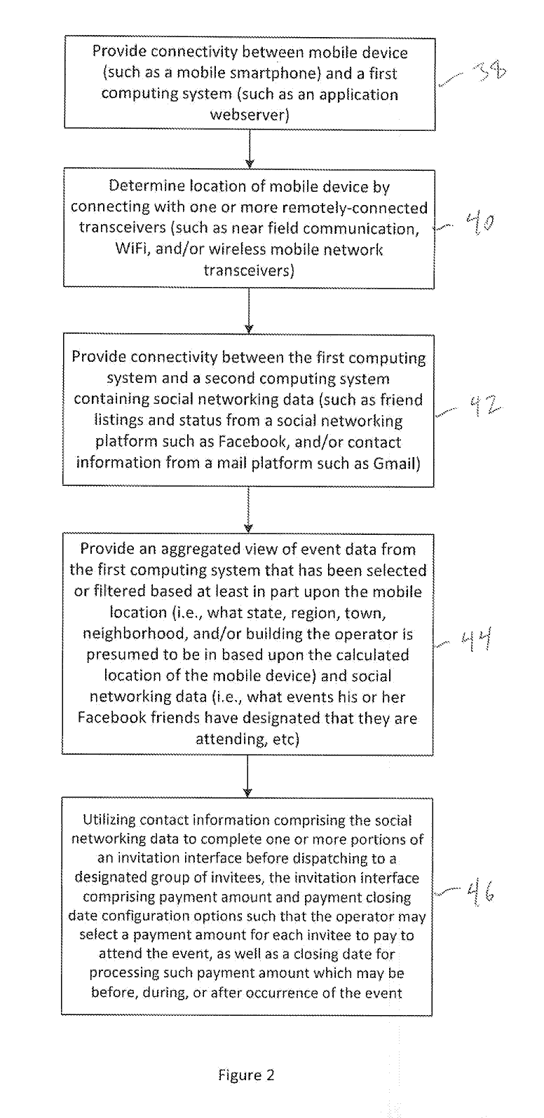

Referring to FIG. 2, in one operational configuration, connectivity is established between a mobile computing device and a first computing system (38); the mobile computing device may be localized utilizing information from one or more operatively coupled transceivers (40); the first computing system may be operatively coupled to a second computing system containing social networking data, such as friend listings, relationship status information, and/or contact information from a social networking platform such as Facebook®, and/or contact information from an electronic mail platform such as Gmail® (42). An aggregated view of event data from the first computing system may be presented to the operator of the mobile device that has been selected or filtered based at least in part upon a determined mobile location as well as social networking data (44). The operator may utilize contact information comprising portions of the gathered social networking data to complete one or more portions of an invitation interface before dispatching an invitation to a group of invitees, the invitation interface comprising payment amount and closing information selected by the invitation-creating operator; in one embodiment the closing date, or date that the invitee's credit card will actually be charged, may be selected to be before the event, during the event, or after the event (46).

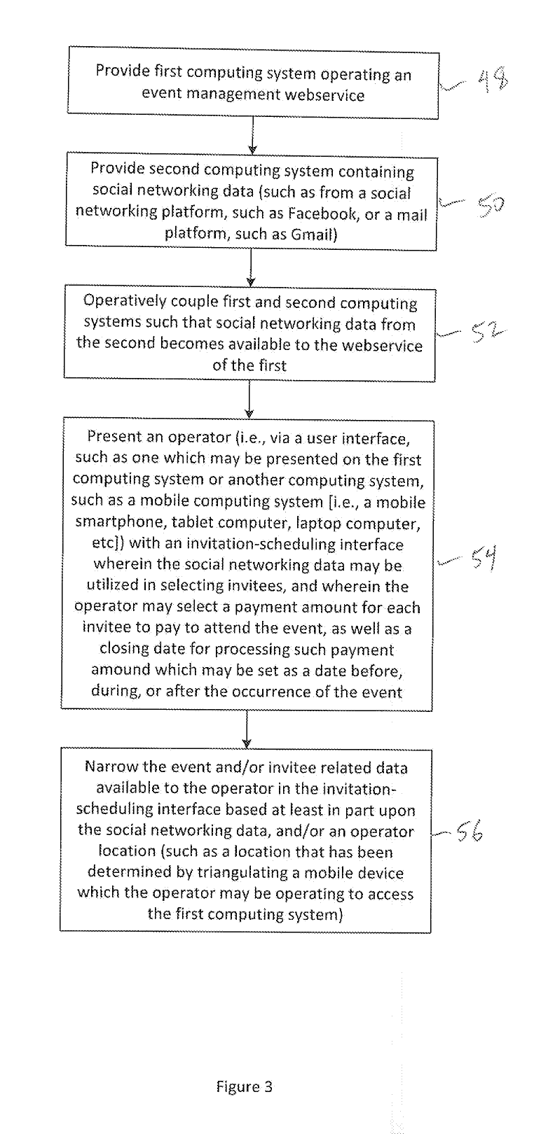

Referring to FIG. 3, in another embodiment, a first computing system may be provided that operates an event management webservice (48); a second computing system may be provided that contains or has access to social networking data (such as from a social networking platform such as Facebook®, or an electronic mail platform such as Gmail®) (50). The first and second computing systems may be operatively coupled, such as via a wireless or wired network using an API, such that social networking data from the second becomes available to the webservice of the first (52). Given such configuration, an operator may be presented (i.e., via a computerized user interface)with an invitation-scheduling/management interface, such as on his mobile device, or on the first computing system if he or she is operating that directly, wherein the social networking data may be utilized to select invitees, and wherein the operator may select a payment amount for each invitee to pay to attend the event, as well as a closing date for processing such payment amount (i.e., via a credit card electronic process), which may be set as a date before, during, or after the occurrence of the event (54). In one embodiment, the event and/or invitee related data available to or immediately viewed by or presented to the operator may be narrowed or filtered based at least in part upon the social networking data, and/or an operator location (which, in the event that the operator is utilizing a mobile device, may be gathered as described above using triangulation techniques) (56).

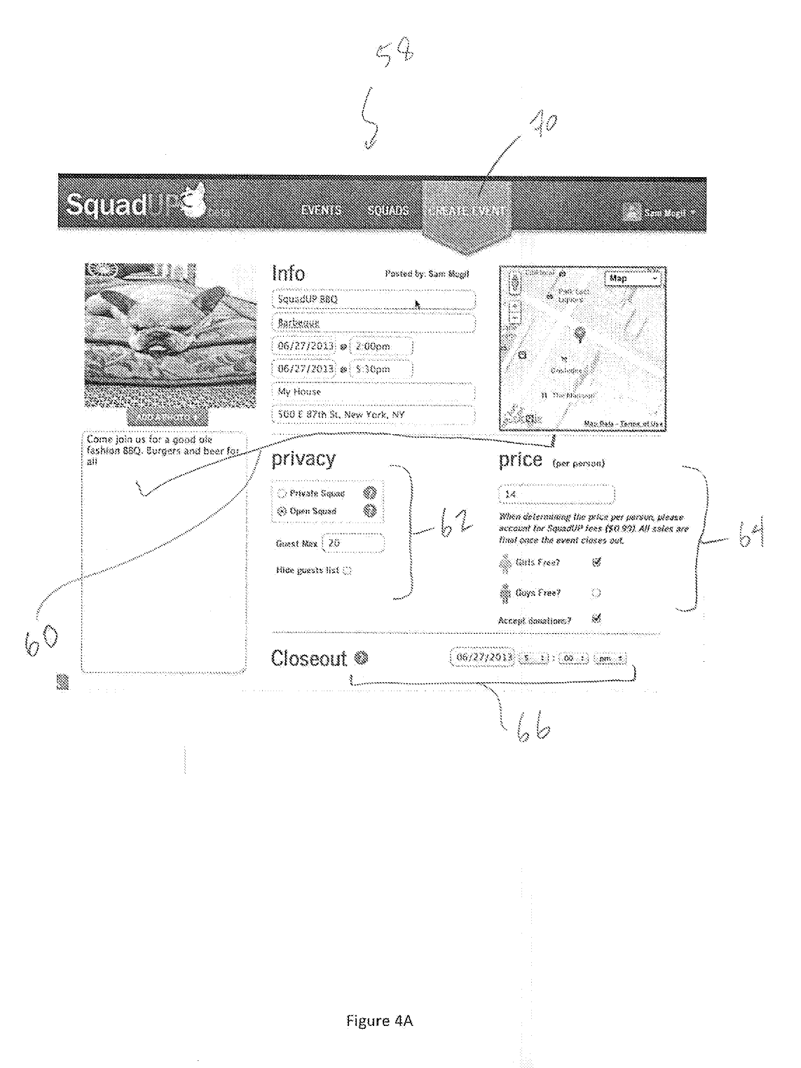

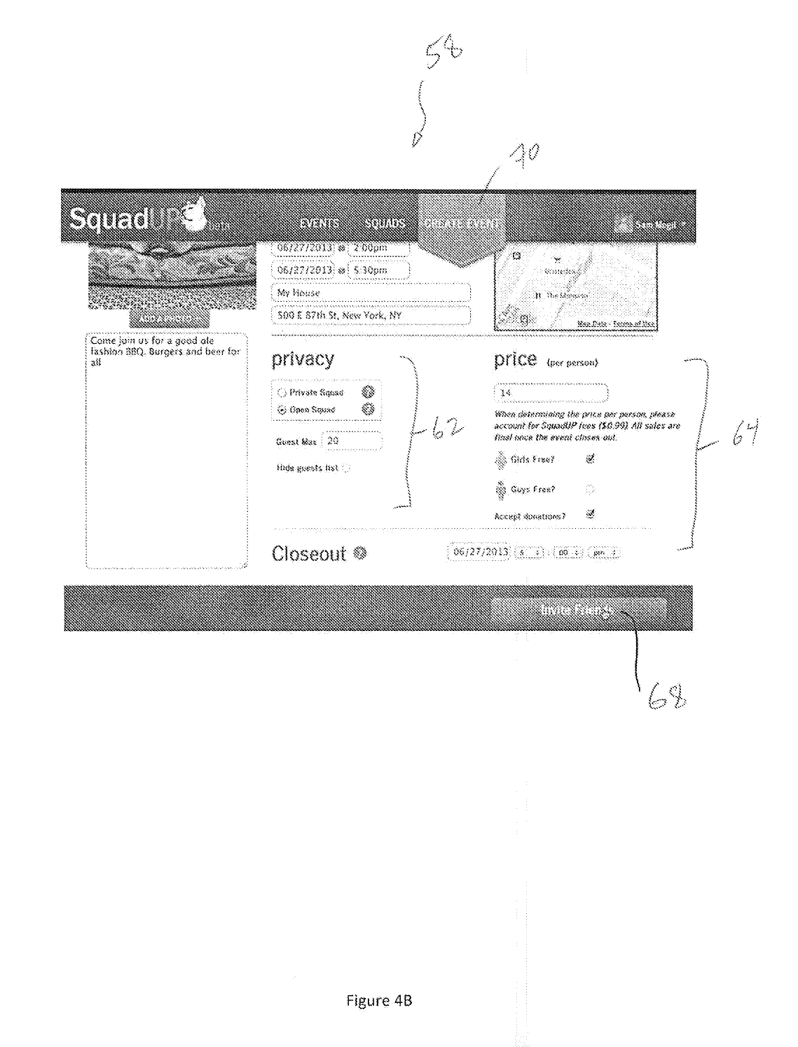

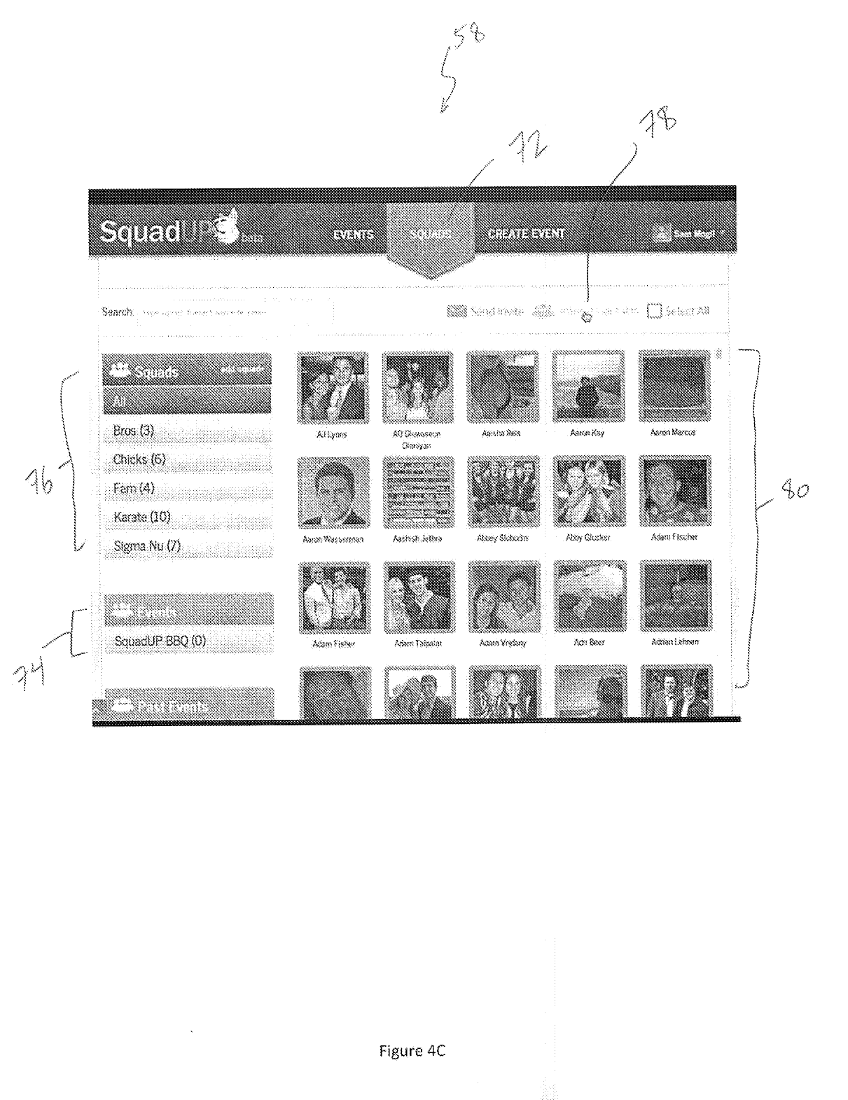

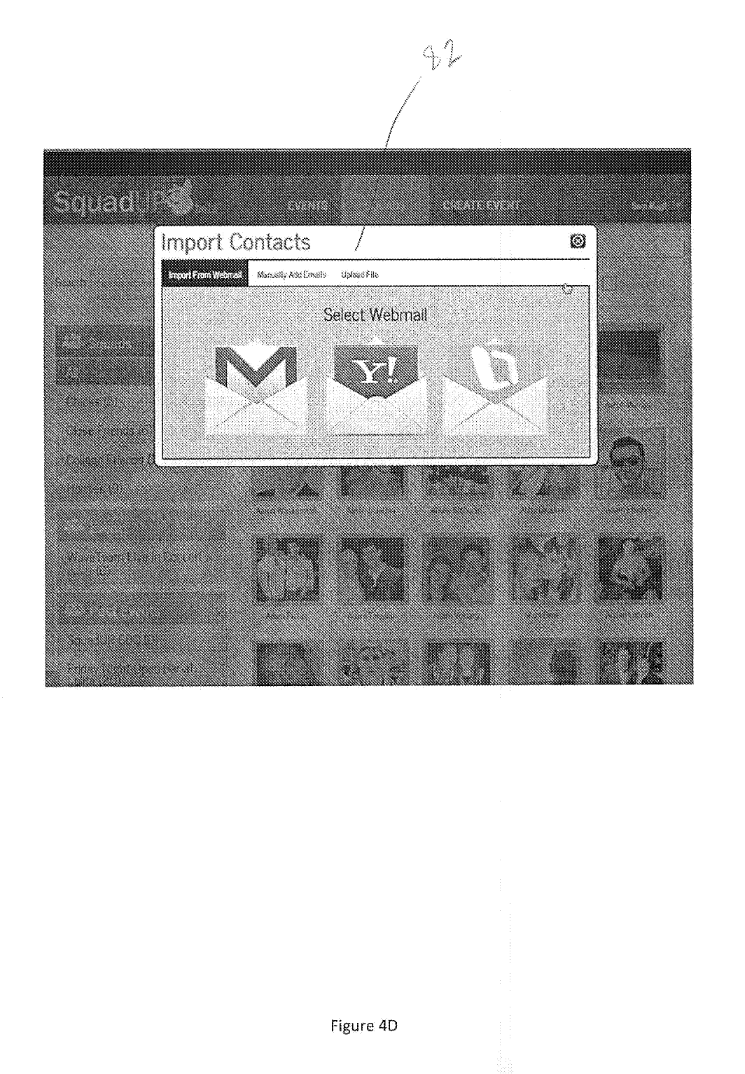

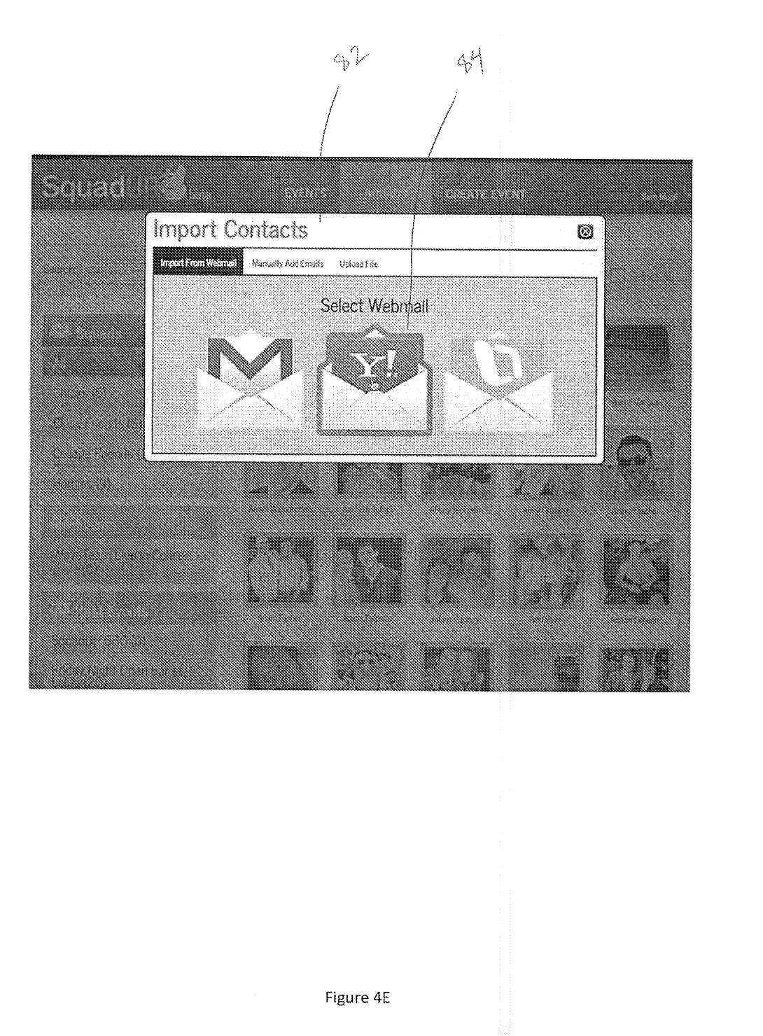

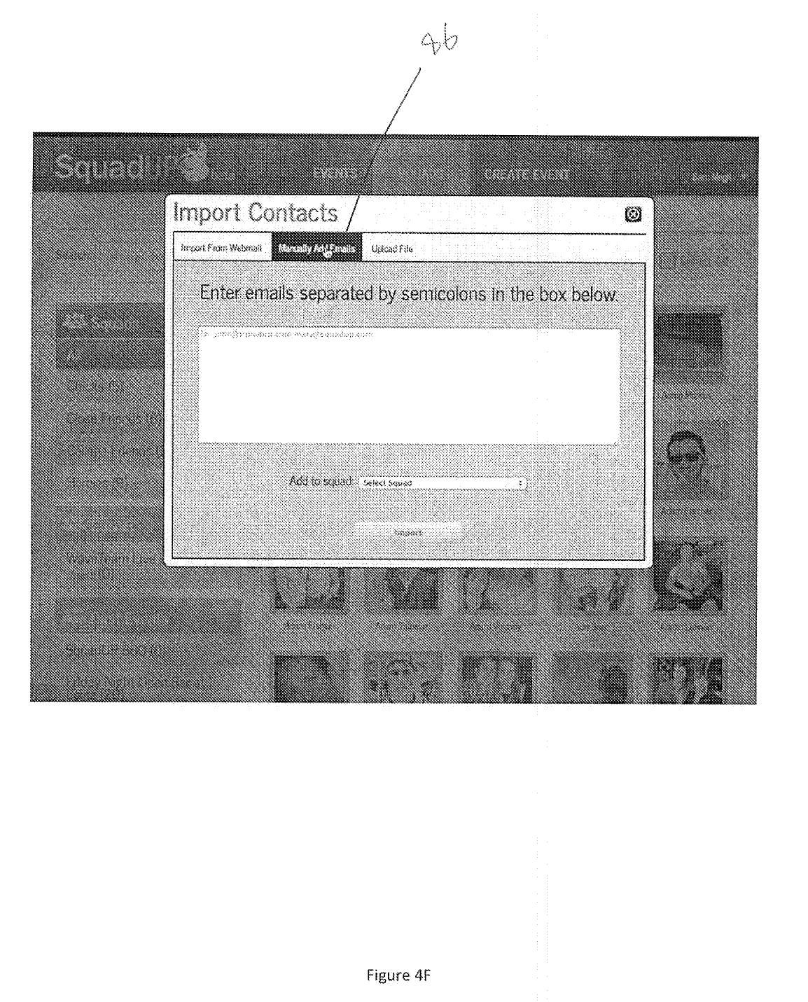

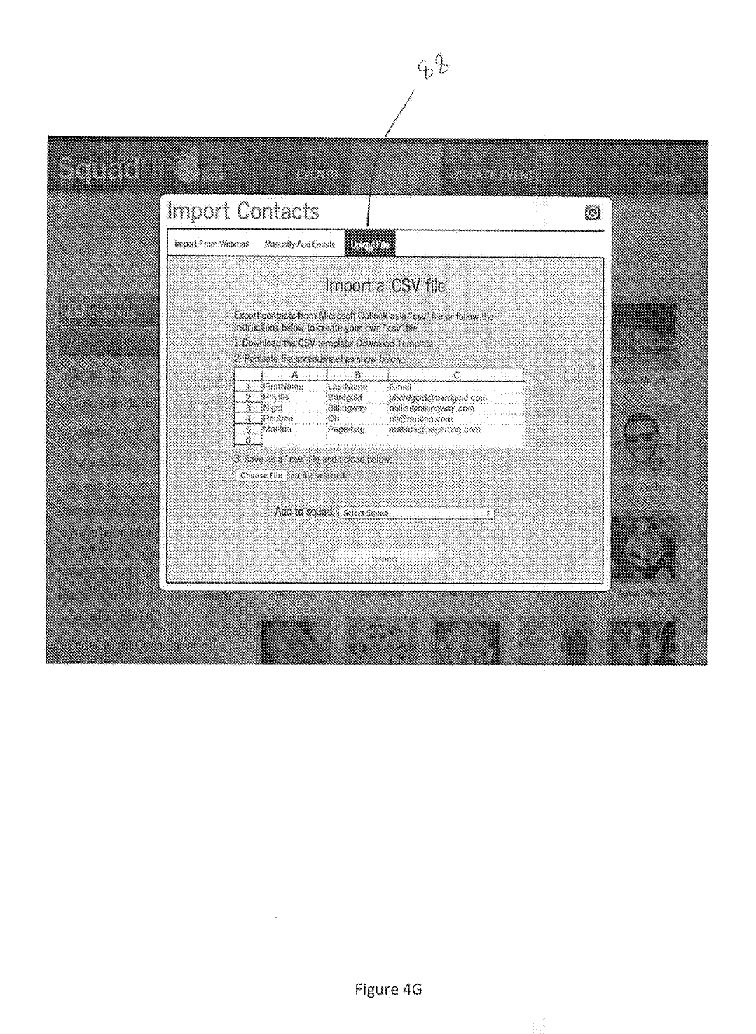

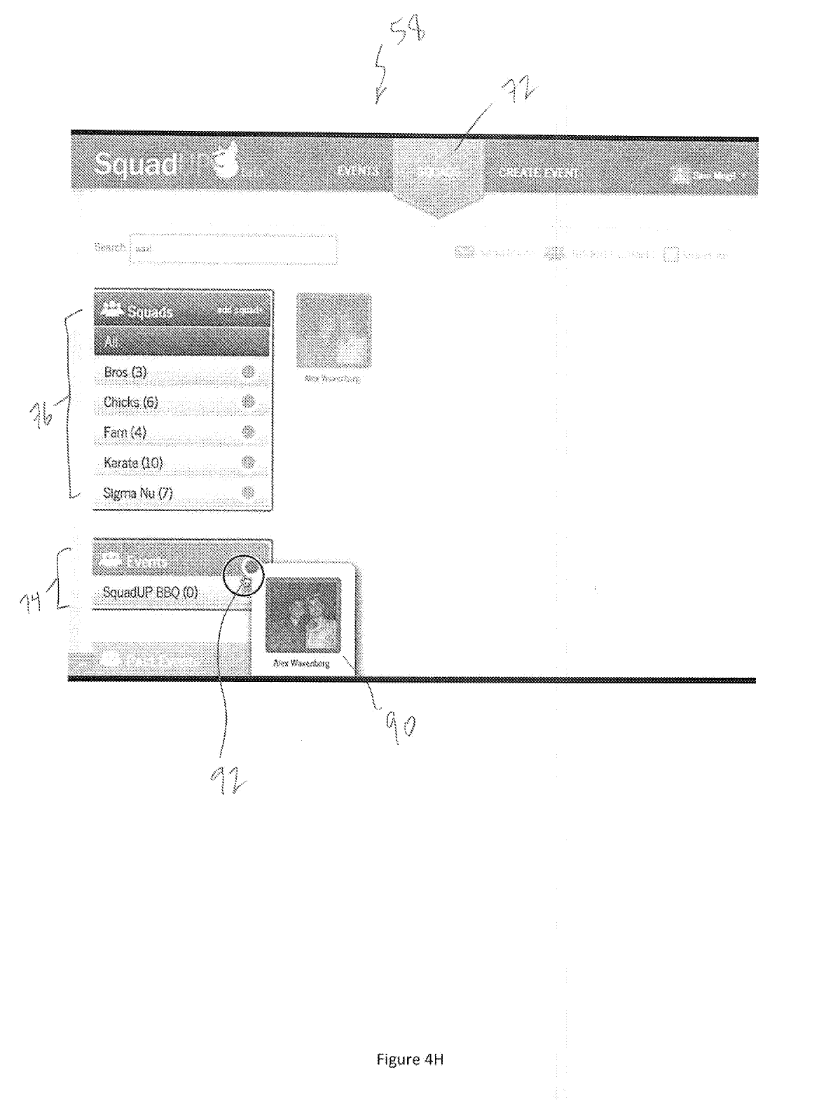

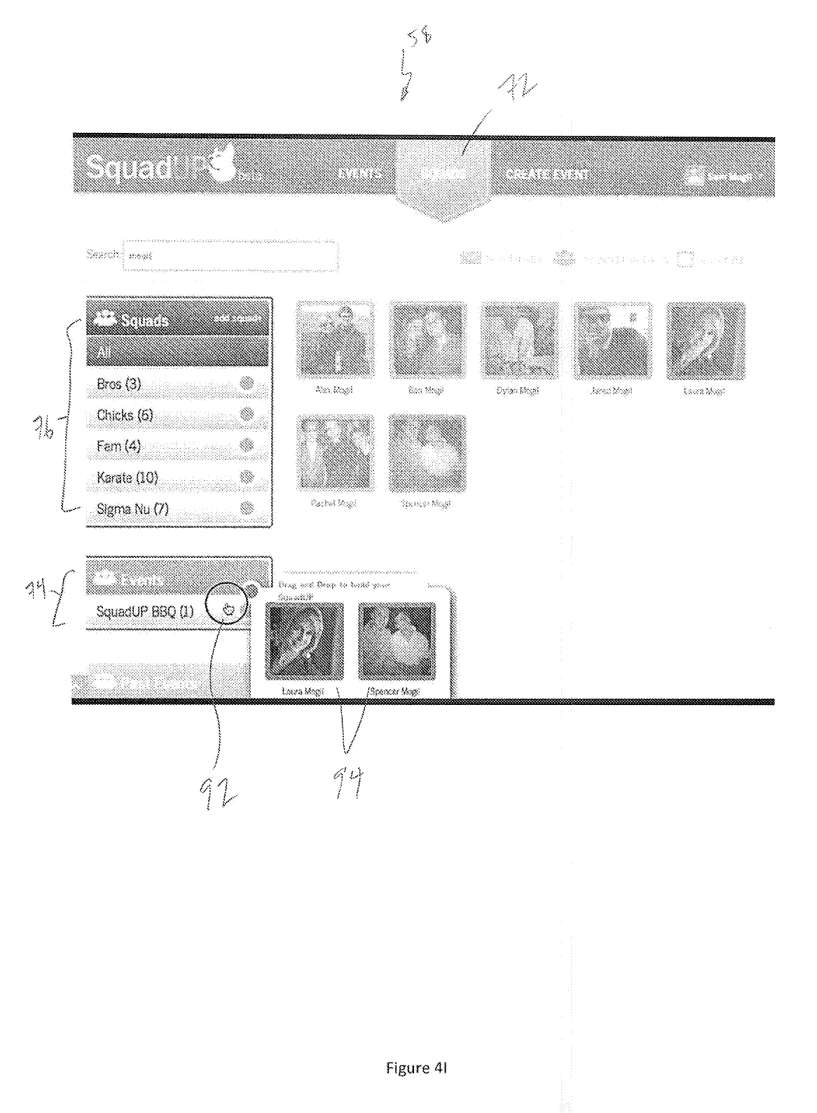

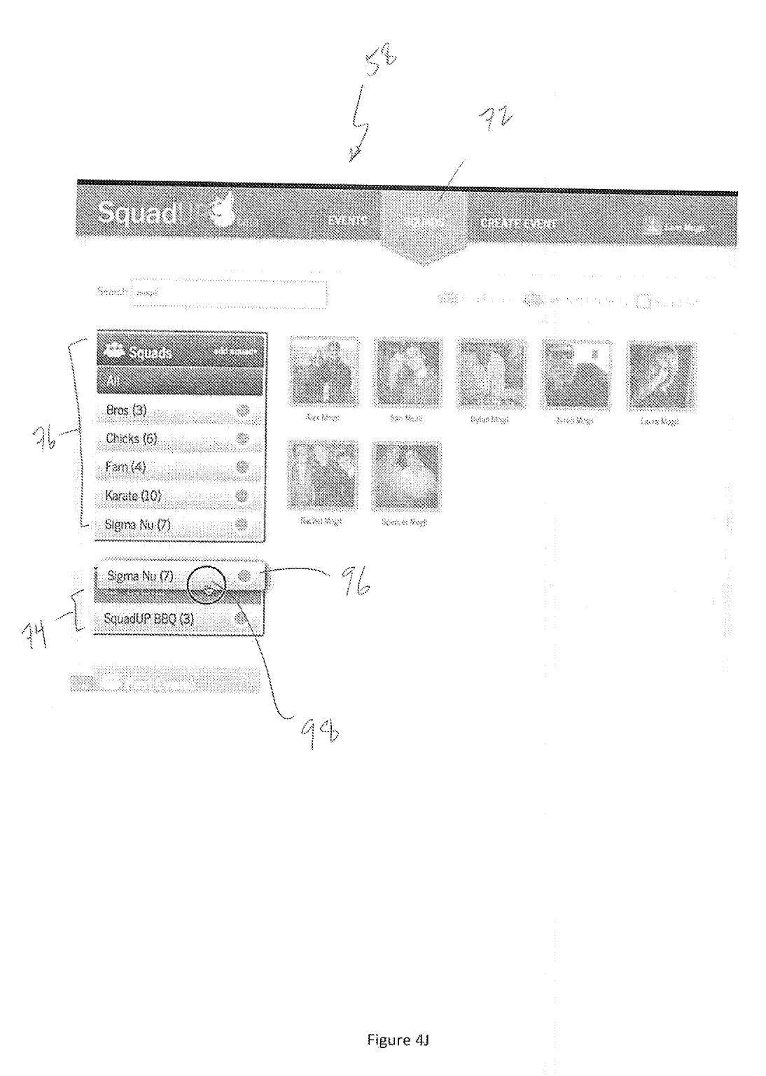

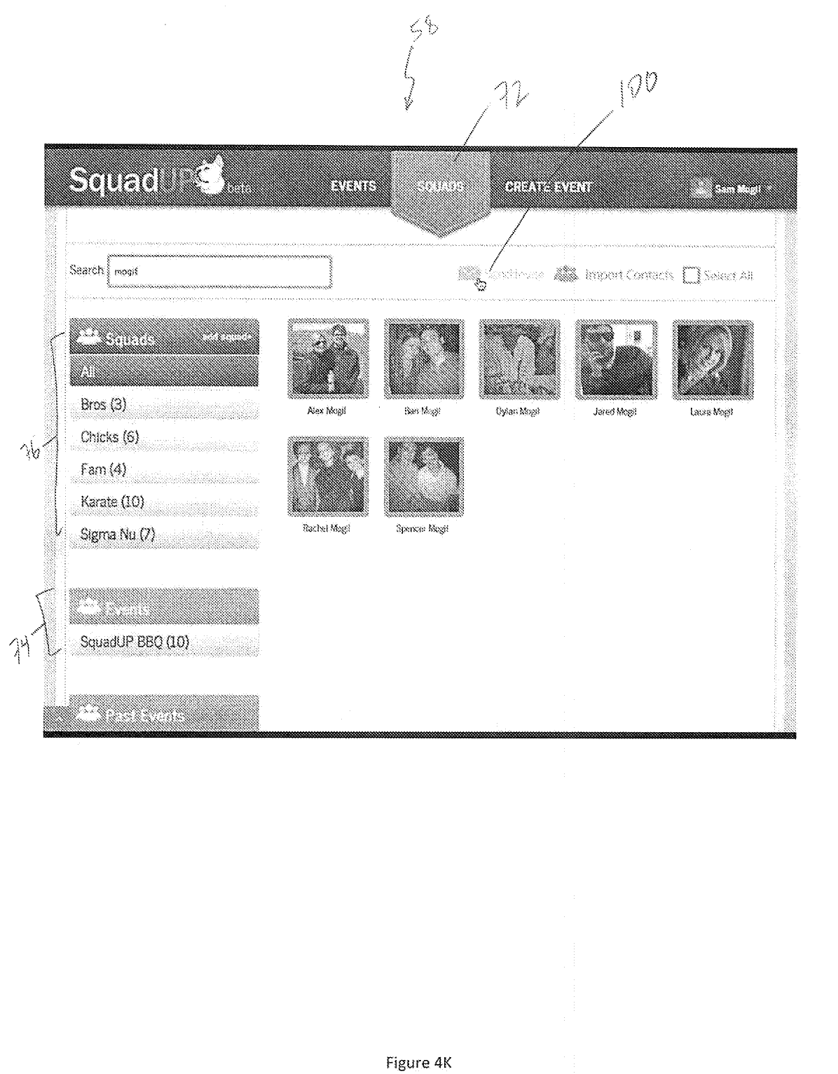

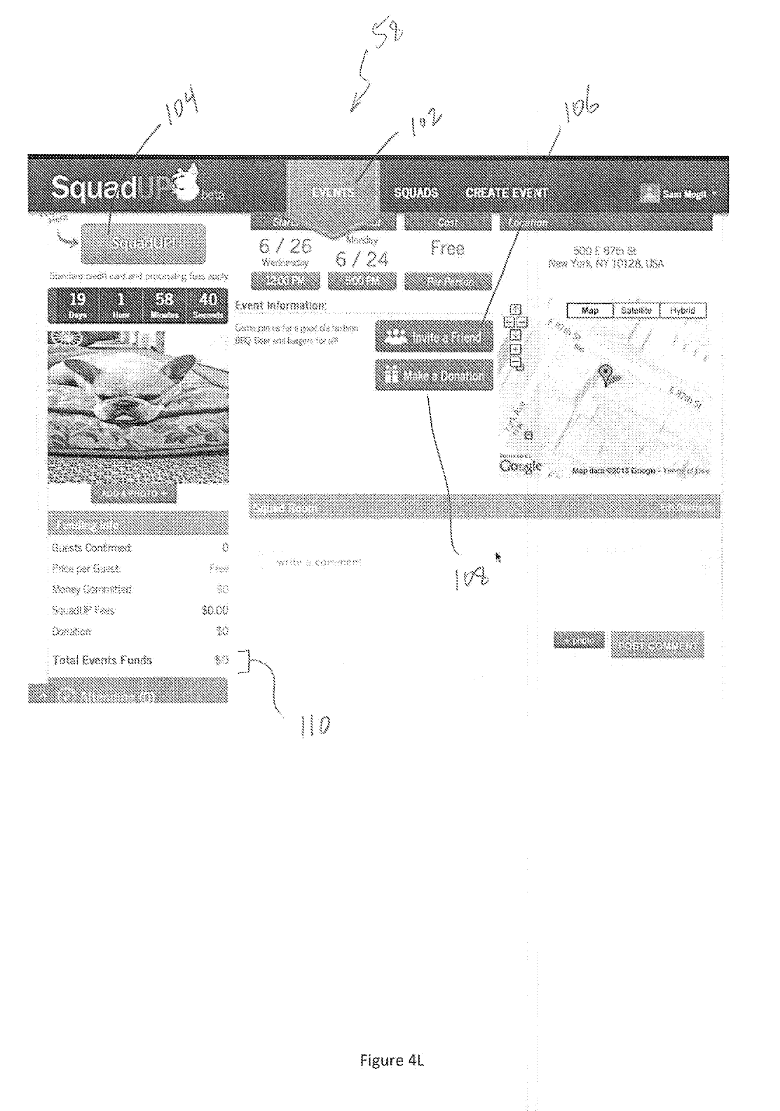

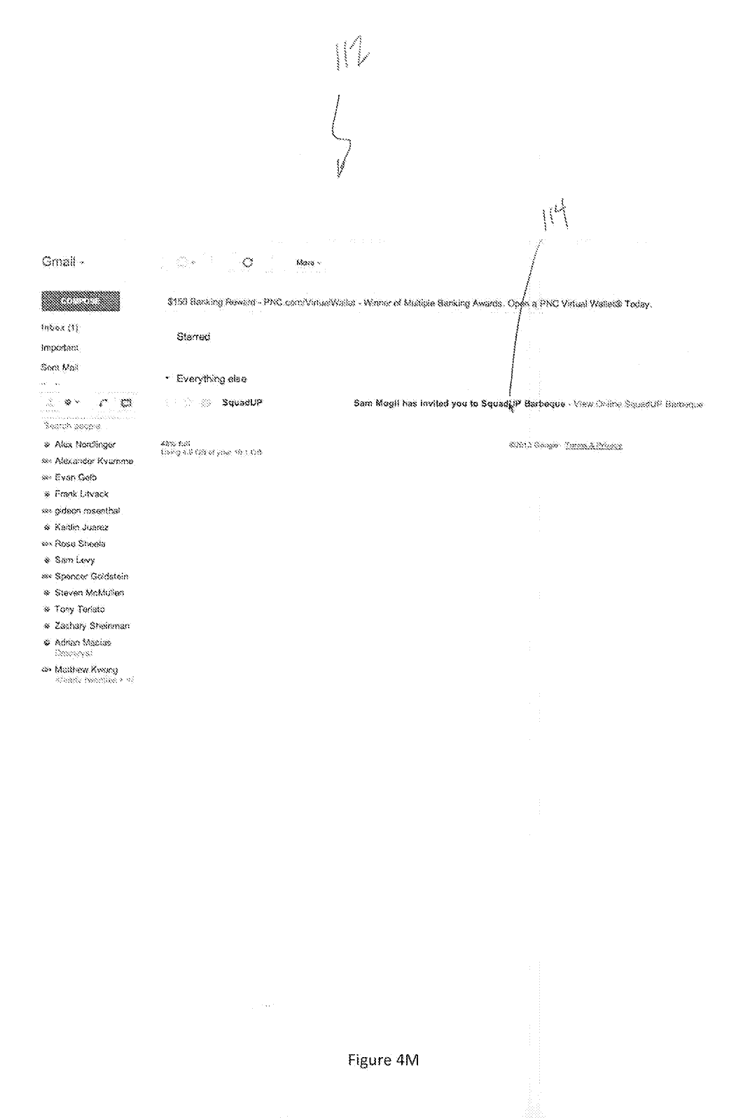

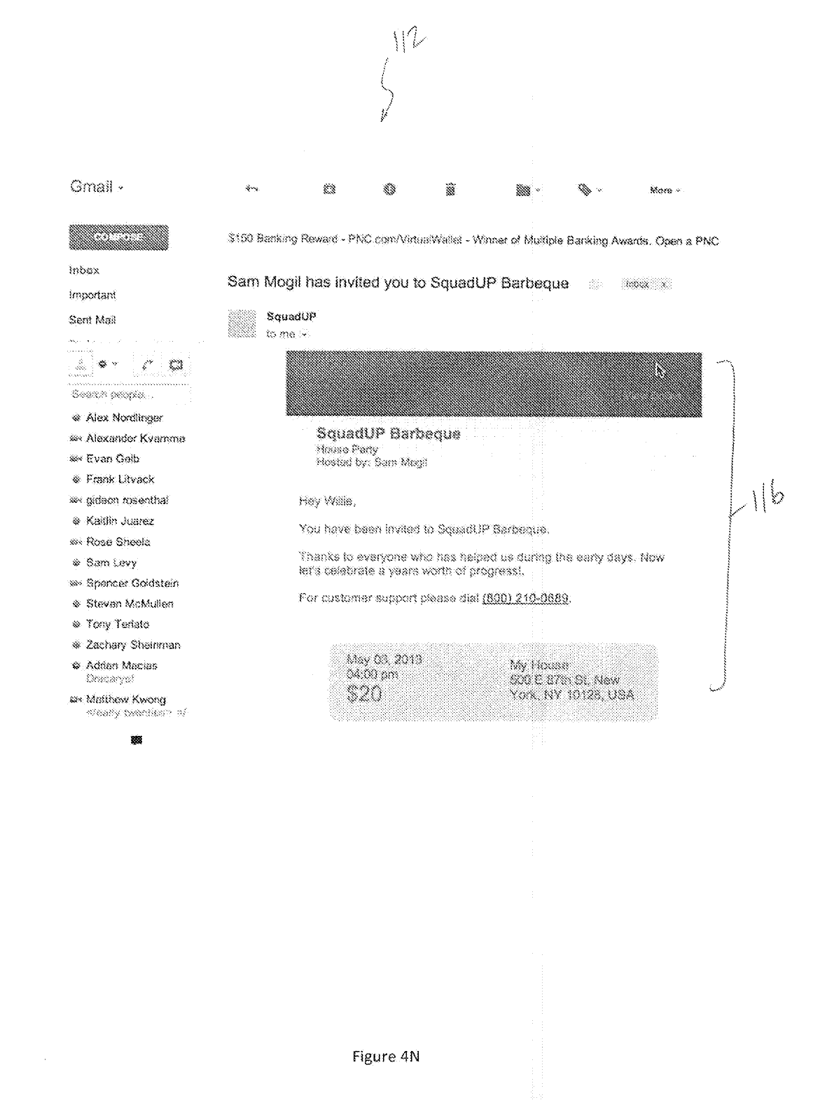

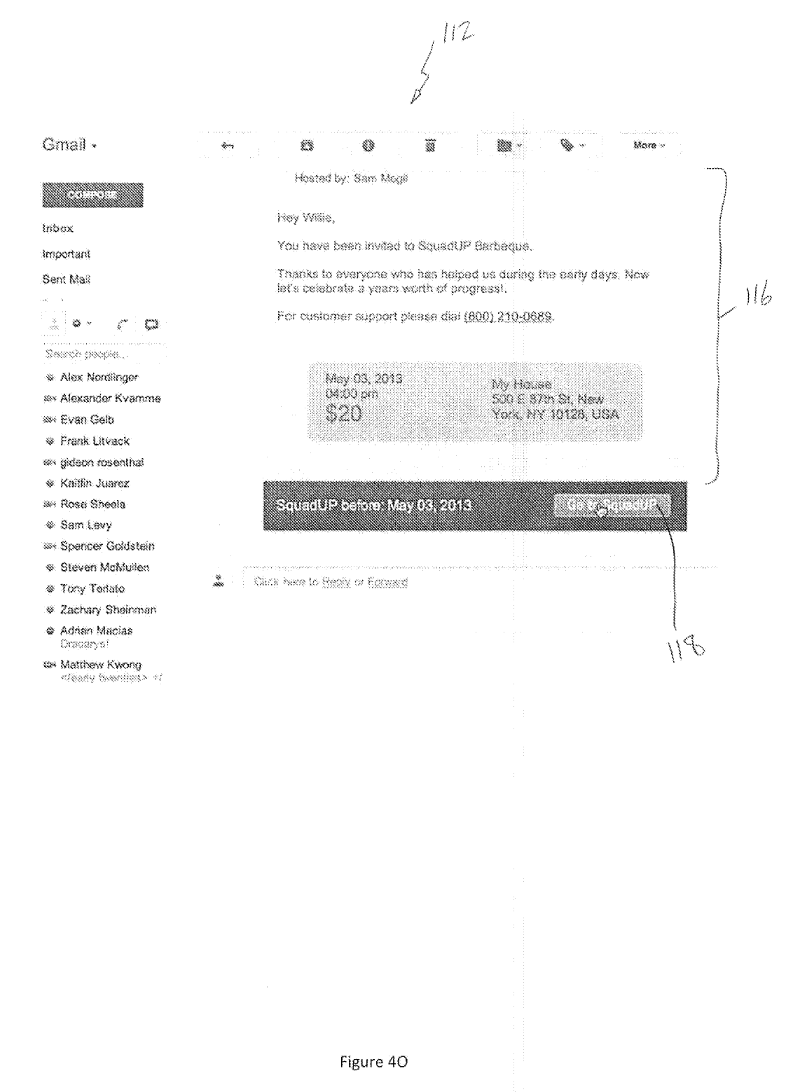

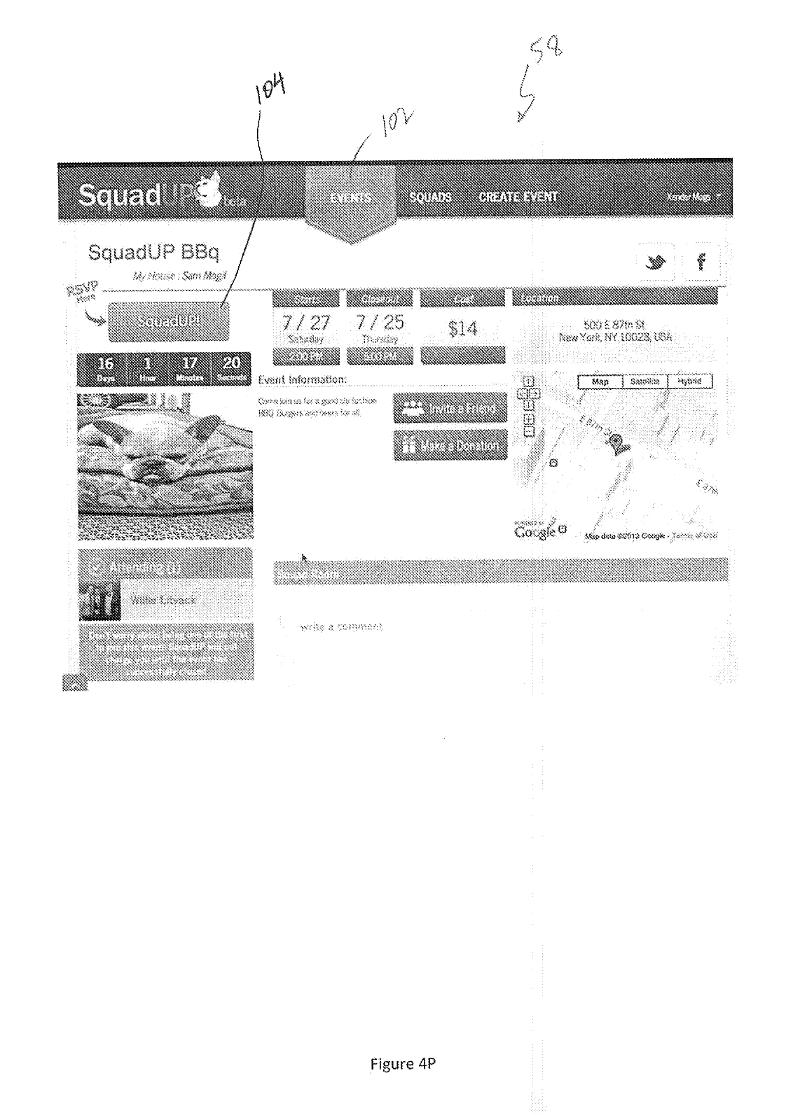

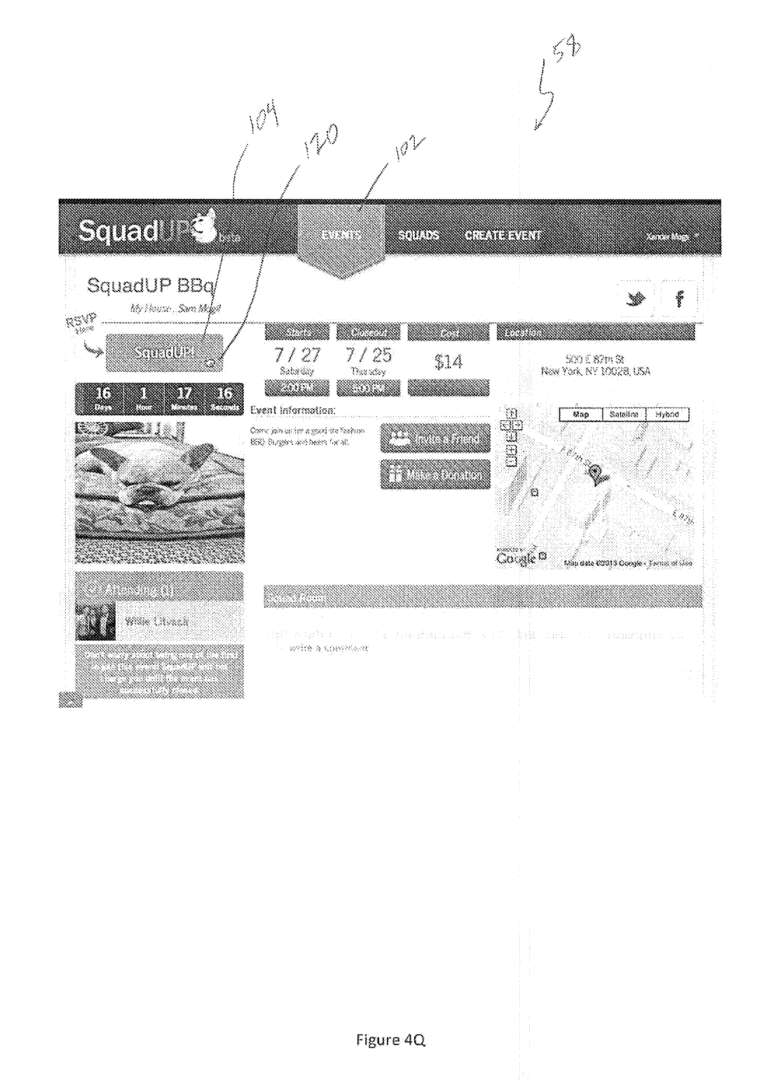

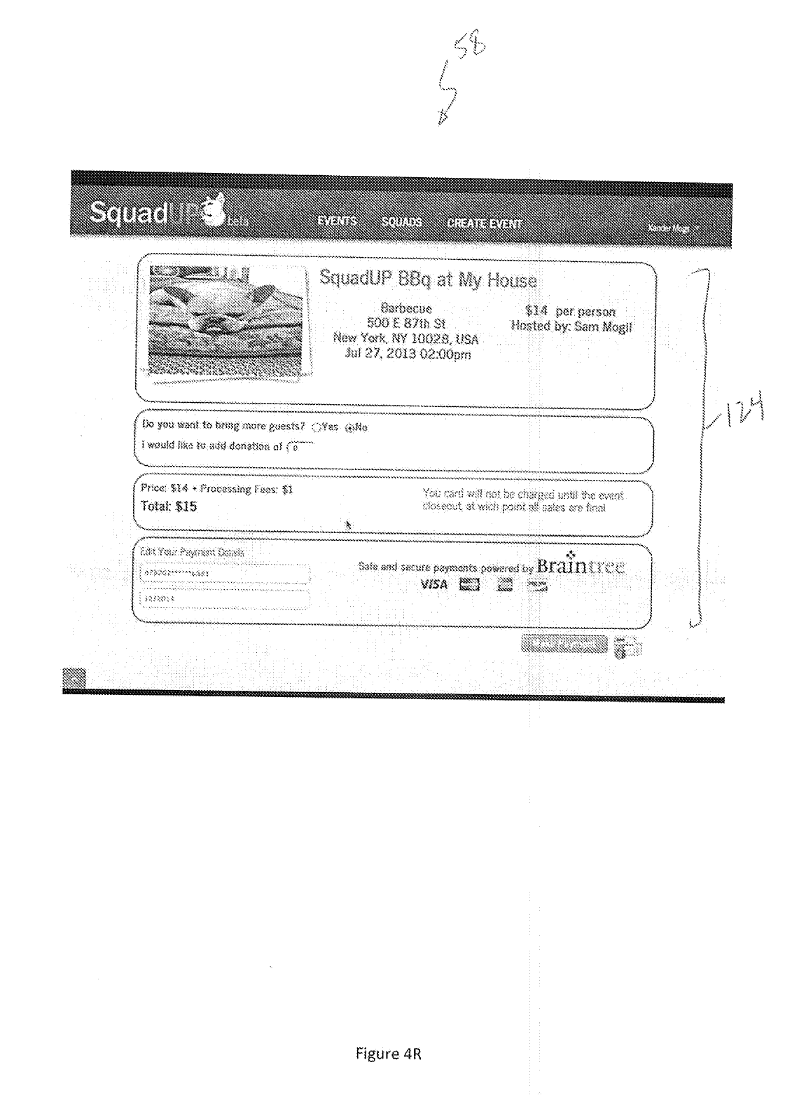

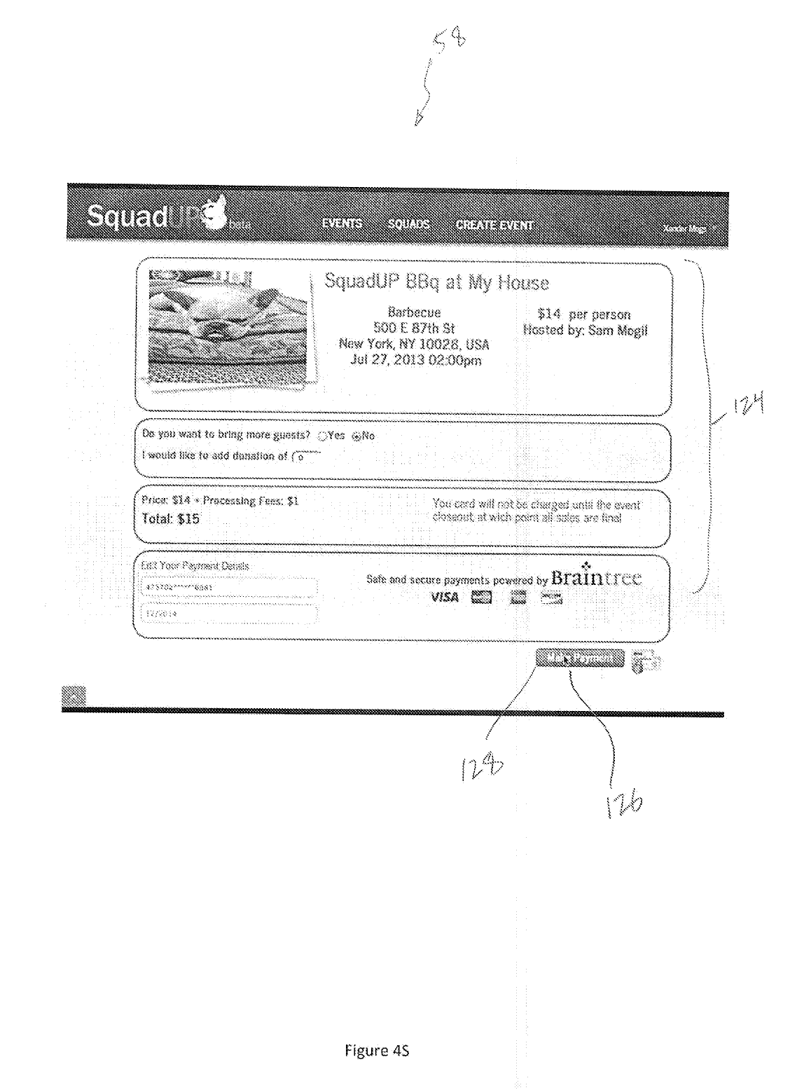

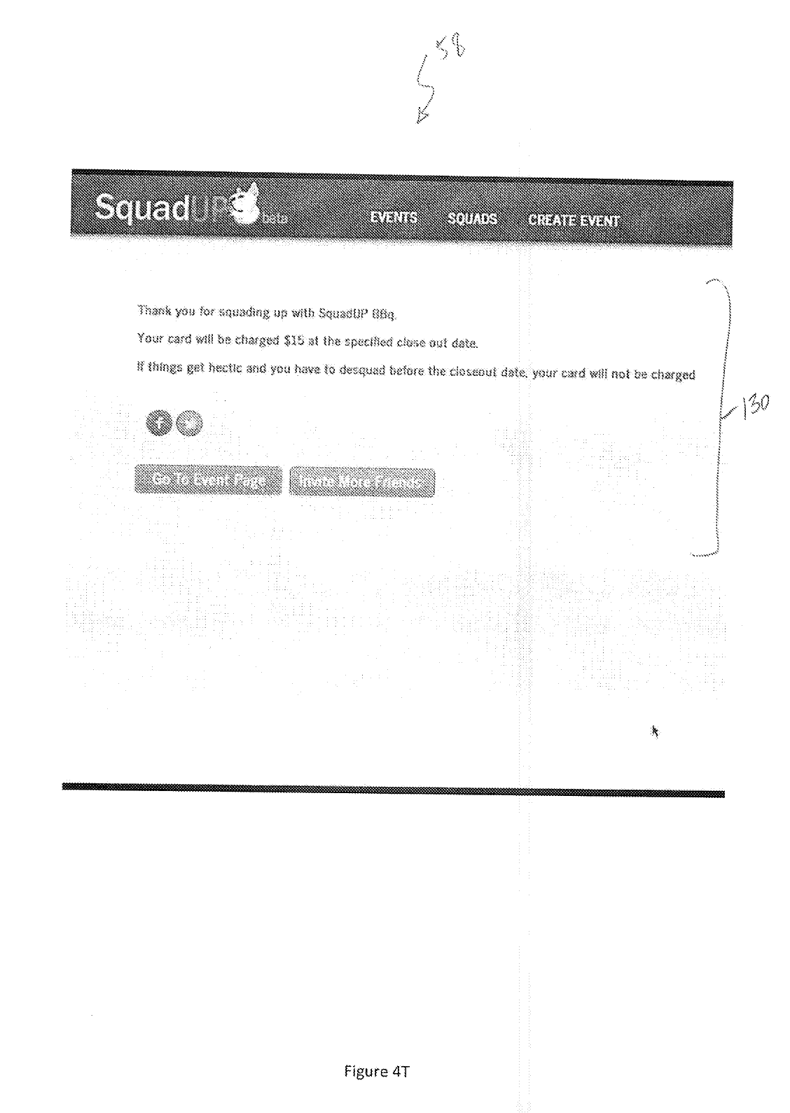

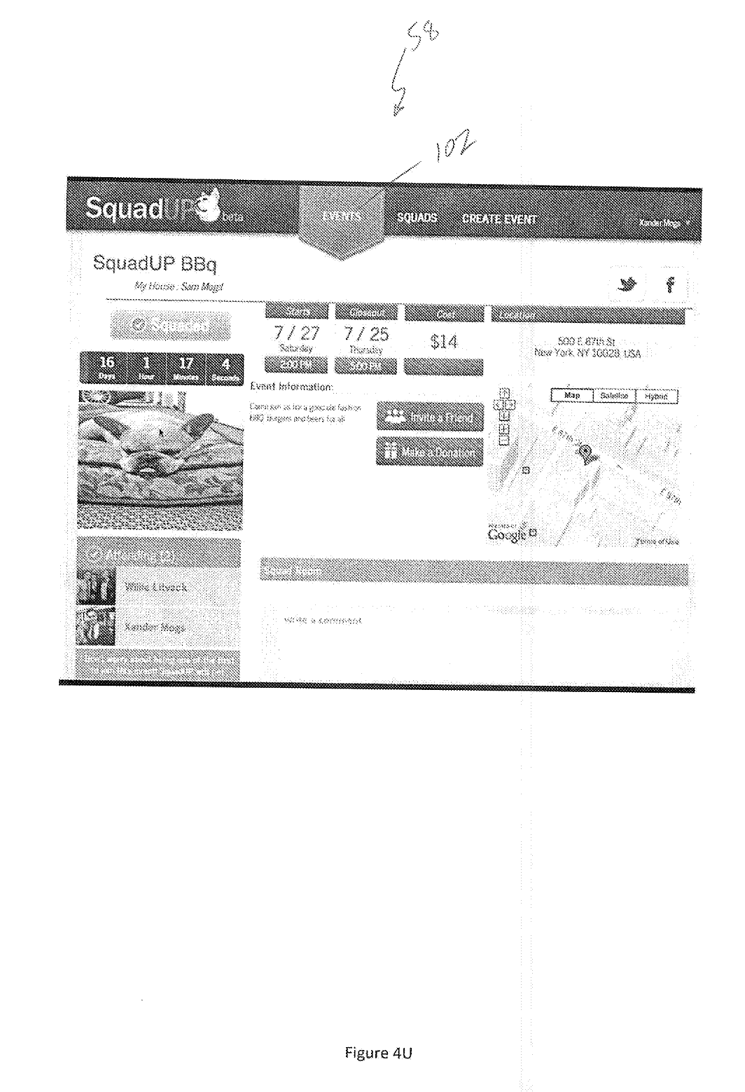

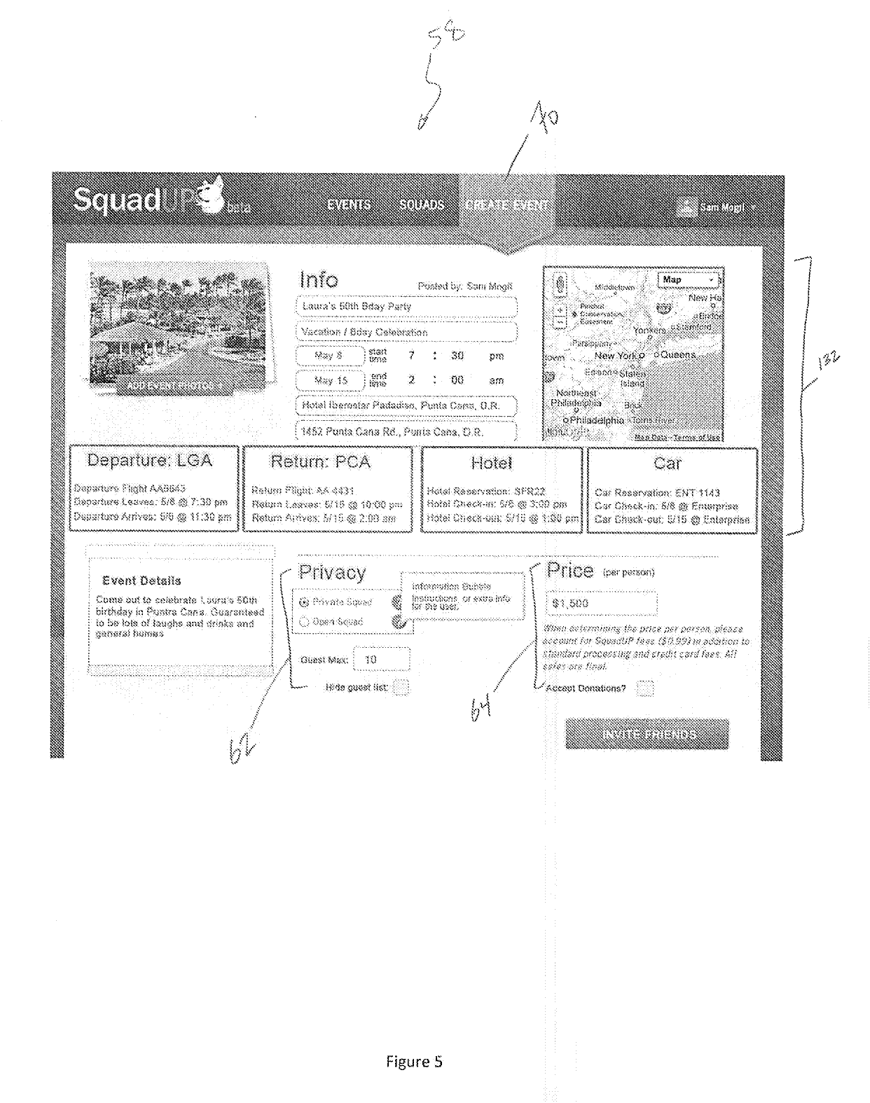

Referring to FIGS. 4A-4U and FIG. 5, various aspects of operational embodiments are depicted in user interface form to further illustrate concepts such as those described above in reference to FIGS. 1-3. In one embodiment the user interface depictions (58) in FIGS. 4A-4U and FIG. 5 may be generated using a first computing system (2) such as that depicted in FIG. 1, with the associated intercoupled other computing and data resources.

Referring to FIG. 4A, a user interface (58) configuration is shown featuring a “create event” website tab (70) that allows an operator to create a new event from any connected device (i.e., a connected mobile smartphone, tablet computer, laptop computer, desktop computer) using the webservice hosted from a system such as the first computing system (2) of FIG. 1. An event information area (60) allows the operator to easily enter information about the new event, and a mapping of the neighborhood of the entered address may be automatically generated using resources such as those available from GoogleMaps® webservices. A privacy area (62) allows the operator to select “open” (in which case each invitee may invite other invitees) or “closed” (in which case the originator controls the invitation list) event status, a maximum number of guests, and other features such as whether the guest list is to be viewable or readily visible to all invitees. A price area (64) allows the inviting operator of the webservice to set a price per person for the event (which may be determined, for example, based upon the costs of the event); other selectable features include gender-based “free” access controls, and donation acceptance options. A “closeout” area of the depicted user interface (58) allows the operator/invitor to dictate when the financial aspect of each accepting guest (i.e., each guest who RSVPs) will close from a temporal perspective; in other words, the invitor decides when each of the positively responding guests' credit cards (or whatever other payment means is utilized) will be formally charged.

Referring to FIG. 4B, with the requisite details described in reference to FIG. 4A completed, the operator/invitor may select an “invite friends” field/button (68) in the user interface (58) of the webservice presentation, which leads the operator/invitor into a guest list, or “squad”, setup configuration, as described below (the subject webservice may be termed “SquadUP” ™; the term “squad” may be used in reference to a guest list for a given current or previous event, and the term “squad up” may be used in reference to accepting an invitation to join a squad or event).

Referring to FIG. 4C, a squad tab (72) of a user interface (58) embodiment is shown with various already-available contacts depicted (80) in this particular user's account; a listing of previous squads (76) also is featured, as well as a listing of current events (74), which includes the “SquadUP BBQ” event that was just initiated as discussed in reference to FIGS. 4A-4B. With a selection of an “import contacts” field (78) in the user interface (58), additional contacts may be imported from other connected resources, such as the second computing system (4) described in reference to FIG. 1. Referring to FIG. 4D, selection of the “import contacts” field (78) in the user interface (58) view of FIG. 4D may lead to a dialog box/selection interface (82) as shown, wherein contact information may be imported from a webmail application such as Gmail® or Yahoo Mail®; FIG. 4D shows that Yahoo Mail® has been selected (84), allowing the operator to bring selected contacts into his SquadUp account from his Yahoo Mail® account. FIG. 4F illustrates that email contacts may be manually added (86) by typing in email addresses into the depicted user interface. FIG. 4G illustrates that contacts also may be imported from a file (88), such as in comma separated values (“CSV”) form as shown in the depicted user interface.

Referring to FIG. 4H, the operator has utilized a search field in the squads tab (72) area of the user interface (58) to search for a particular contact name; after this contact has been identified, the system may be configured such that the operator can drag (92) the contact (90) over to the current event at issue (74) and drop it (i.e., “drag” and “drop” via a computer user interface input device such as a mouse; finger drag functionality may suffice as well in touchscreen interfaces, such as those common on many mobile computing devices), thereby causing the system to add the particular contact to the squad for the current event. FIG. 41 shows a related configuration wherein the operator has searched for a particular last name and two contacts have been isolated (perhaps a brother and sister, each having the same last name); given the decision to invite both into the current squad, the operator can select both (94) and drag them (92) to the current squad to add them.

Referring to FIG. 4J, the operator has decided to invite his entire pre-existing (76) “Sigma Nu” squad to the current event—so he drags that squad (96) onto the current event (98) and drops it, thereby adding that entire group to the new squad.

Referring to FIG. 4K, with the squad for the new event complete, at least for now, the operator can select the “send invite” field (100) from the user interface (58) to cause electronic invitations to be dispatched in various pre-selected forms, such as an email form or a Facebook message form.

FIG. 4L shows the “events” tab of a user interface (58) view wherein a dashboard view of the new event (this particular view being the view presented to one of the invitees in the designated squad) is shown with no guests yet confirmed, no funds committed (110); in one embodiment the “funds” display may be selected to appear or not appear by the operator/controller of the event. Since the operator of this particular user interface (58) is an invitee, he is invited to “Squad Up” (i.e., RSVP) with a selectable field (104); since the event was set up as an open event, he is also invited to invite others with an “invite a friend” field (106) and/or donate funds with a “make a donation” field (108). This particular user may have arrived at the user interface of FIG. 4L by clicking a link (114) in an email interface (112) such as that depicted in FIG. 4M, wherein the user was invited through his email contact information as a member of the proposed squad for the event, as described above. FIG. 4N illustrates a version of an invite email (112) with graphic features (116) and at the bottom of such email, as shown in FIG. 4O, a field (118) which may be selected to take the user to a user interface such as that depicted in FIG. 4L.

FIGS. 4P-4U illustrate an invited guest going through the phases of RSVP (“squadding up”) in one embodiment. As shown in FIG. 4P, the invitee/user sees the event in the events tab (102) of the user interface (58) and is invited to RSVP with a Squad Up field (104). FIG. 4Q illustrates a cursor selection (120) of such field (104), which leads to the payment dialog interface (124) shown in FIG. 4R. Referring to FIG. 4S, with the information completed, the user may select (126) the “make payment” field/button (128) to confirm his RSVP (and receive a final confirmation such as that depicted in FIG. 4T 130), and at such point the webservice may be configured to do an initial payment confirmation with the connected payment service (such as the third computing system 6 of FIG. 1) to confirm simple information such as name matches card number, etc; the payment is not formally processed until the designated closing date, and in one embodiment, an invitee who has RSVPed may back out of the event at any time and have no financial exposure prior to the closing date. FIG. 4U illustrates the “events” tab (102) dashboard view with updated attendee information. In one embodiment, a “squad room” feature of the event allows members of the squad to communicate with each other, post photos, videos, comments, etc—all with exposure only to the members of the squad, and in real or near-real time depending upon network connectivity and whether members of the particular squad are carrying mobile computing/communication devices. This may be highly desirable versus the somewhat public access provided when using other communication systems such as posting walls or public chatrooms. For example, in one scenario it may be desirable for a squad attending a bachelorette or bachelor party to post items in real time which are not available to anyone else outside of the squad (such as a posting of a comment and/or photo or video stating to the squad, “you need to see this third floor bartender . . . ”). Further, the squad room may be utilized after the event as a private forum for posting comments, photos, videos, and the like after the event has been completed.

In certain embodiments it may be desirable to confirm that invited guests have actually attended an event (i.e., to prevent them from being charged for an event that they have not attended); in one embodiment, this may be accomplished using a simple user interface checklist operated by the invitor or any of his designees (i.e., such as one or more bouncers at a club with connected smartphones); the checklist may be replaced with somewhat more automated and/or secure technologies, such as barcodes or QR codes, which may be utilized in a manner akin to the manner in which airlines utilize use barcodes or QR codes for ticketing and boarding pass functionality. Indeed, in one embodiment, wherein an event is selected to have a large number of guests, a group of gate access controllers may use barcodes or QR code functionality in a manner akin to conventional printed ticket functionality at a music performance or concert, which each attending guest gaining physical access after producing the appropriate barcode or QR code. The webservice may also be configured to allow guests to print tickets, barcodes, QR codes, and the like so that electronic mobile devices need not be brought along to a particular squad event.

Referring to FIG. 5, in one embodiment various travel aspects and resources (132) may be managed and organized as part of an event. For example, rather than a relatively straightforward BBQ event as illustrated above, the subject technology may be utilized to plan, execute, and follow-up upon more sophisticated challenges such as multi-aspect spring break trips or out-of-state ski week trips. The paradigm for operating the webservice is similar to that described above in reference to the BBQ event, with the addition of travel resource management, which may involve integration with other systems, such as those (8) depicted in FIG. 1. For example, in an exemplary embodiment, an operator/invitor may assemble a squad to do a weeklong ski trip out of state in Aspen, Colo. The webservice would be integrated with travel resources to allow for the operator/invitor to transiently put a hold on a block of flights for air travel, as well as a block of hotel rooms for lodging; the webservice also would allow for the purchase of lift tickets for skiing at Aspen. As described above, the operator/invitor would assemble his or her squad, and dispatch invitations featuring the requisite event information, including a fixed but transient price for the lodging and air transportion (i.e., if you Squad Up within the next 48 hours, you are guaranteed one of the flights and hotel rooms in the block held for this event; if you do not, you are on your own for air travel and lodging); preferably the travel resource provider(s) would have computing systems integrated, such as via programming API as described above, to facilitate total automation/integration so that the users of the subject webservice may handle their entire transaction through the subject webservice.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject systems. The methods may comprise the act of providing such a suitable system. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A system for assisting an operator to view events, comprising:
a. a first centralized computing system; and
b. a mobile computing device operatively coupled to the first centralized computing system and configured such that a mobile location may be determined based at least in part upon wireless communications between the mobile computing device and one or more remote transceivers positioned in known locations;
wherein the first centralized computing system is configured to operate an event management webservice, and is operatively coupled to a second centralized computing system containing social networking data; and
wherein the mobile computing device may be operated to view a selection of event data received from the first centralized computing system that has been selected based at least in part upon the mobile location and the social networking data.

2. The system of claim 1, wherein the first centralized computing system is a webserver.

3. The system of claim 1, wherein the mobile computing device is selected from the group consisting of: a mobile phone, a tablet computer, and a laptop computer.

4. The system of claim 1, wherein the mobile computing device is operatively coupled to the first centralized computing system via a wireless network.

5. The system of claim 4, wherein the wireless network comprises a mobile wireless network.

6. The system of claim 4, wherein the wireless network comprises a WiFi network.

7. The system of claim 1, wherein the second centralized computing system is a webserver.

8. The system of claim 7, wherein the webserver is configured to host one or more portions of a social network platform.

9. The system of claim 8, wherein the one or more portions of a social network platform comprise a database featuring user relationship information.

10. The system of claim 9, wherein the user relationship information comprises contact information.

11. The system of claim 9, wherein the user relationship information comprises relationship status information.

12. The system of claim 11, wherein the relationship status information comprises friend status.

13. The system of claim 7, wherein the webserver is configured to host one or more portions of an electronic mail platform.

14. The system of claim 13, wherein the one or more portions of an electronic mail platform comprise a database featuring contact information.

15. The system of claim 1, wherein at least one of the one or more mobile transceivers is a mobile wireless transceiver.

16. The system of claim 15, wherein a plurality of mobile wireless transceivers is configured to be utilized to determine the mobile location with triangulation techniques.

17. The system of claim 1, wherein at least one of the one or more mobile transceivers is a satellite positioning transceiver.

18. The system of claim 17, wherein a plurality of satellite positioning transceivers is configured to be utilized to determine the mobile location with triangulation techniques.

19. The system of claim 1, wherein at least one of the one or more mobile transceivers is a near-field-communications transceiver.

20. The system of claim 19, wherein a plurality of near-field-communications transceivers is configured to be utilized to determine the mobile location with triangulation techniques.

21. The system of claim 1, wherein the event management webservice is further configured such that the operator may utilize contact information comprising the social networking data to complete one or more portions of an invitation interface before dispatching to a designated group of invitees, the invitation interface comprising payment amount and payment closing date configuration options such that the operator may select a payment amount for each invitee to pay to attend the event, as well as a closing date for processing such payment amount which may be before, during, or after occurrence of the event.
